(19) United States
(12) Patent Application Publication
(10) Pub. No.: US 2004/0032123 A1
(43) Pub. Date: Feb. 19, 2004

(54) Angle-adjustable connector

(76) Inventor: Li-Yun Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,879

(22) Filed: Aug. 13, 2002

(51) Int. Cl. F16L 21/00

(52) U.S. Cl. 285/223; 285/226; 285/233; 285/146.1

(57) ABSTRACT

An angle-adjustable connector is constructed to include two coupling members connectable to a tool and an air compressor/hydraulic press respectively, a connecting tube connected between the coupling members, the connecting tube having two spherical end portions respectively coupled to the coupling members and secured thereto by steel balls for enabling the coupling members to be turned relative to the connecting tube in different directions to different angles, and a bellows sleeve connected between the coupling members around the connecting tube.

### BACKGROUND OF THE INVENTION

1. Field of the Invention

The present invention relates to a connector adapted to connect a tool to an air compressor or hydraulic press and, more particularly to an angle-adjustable connector that can be adjusted to different direction and angles.

2. Description of the Related Art

FIG. 4 illustrates a connector adapted to connect a tool, for example, a sand wheel, drill, or screwdriver to an air compressor or hydraulic press. The connector 5 is a hard member shaped like a tube, having a first connecting portion 51 at one end connectable to the tool and a second connecting portion 52 at the other end connectable to the outlet tube of the air compressor or hydraulic press. This structure of connector is not satisfactory in function. Because the connector is a fixed member, it cannot be rotated with the tool or the outlet tube of the air compressor or hydraulic press. When the user rotates the tool during working, the outlet tube of the air compressor or hydraulic press tends to be tangled, and the connecting area between the tool and the connector or the connecting area between the connector and the outlet tube tends to be damaged. When the outlet tube tangled, the user shall have to arrange the outlet tube properly into a smooth condition.

### SUMMARY OF THE INVENTION

The present invention has been accomplished under the circumstances in view. It is therefore the main object of the present invention to provide a connector for connecting a tool to an air compressor or hydraulic press that can be adjusted to the desired direction and angle. It is another object of the present invention to provide a connector for connecting a tool to an air compressor or hydraulic press, which prevents tangle of the delivery tube connected thereto. To achieve these and other objects of the present invention, the angle-adjustable connector comprises two coupling members connectable to a tool and an air compressor/hydraulic press respectively, a connecting tube connected between the coupling members, the connecting tube having two spherical end portions respectively coupled to the coupling members and secured thereto by steel balls for enabling the coupling members to be turned relative to the connecting tube in different directions to different angles, and a bellows sleeve connected between the coupling members around the connecting tube. Further, seal rings are respectively mounted in the coupling members and stopped against the spherical end portions of the connecting tube to prohibit leakage.

### BRIEF DESCRIPTION OF THE DRAWINGS

FIG. 1 is an exploded view of an angle-adjustable connector according to the present invention.

FIG. 2 is a sectional assembly view of the angle-adjustable connector according to the present invention.

FIG. 3 is similar to FIG. 2 but showing the angular position of the first coupling member and the connecting tube adjusted relative to the second coupling member.

FIG. 4 is a sectional view of a connector according to the prior art.

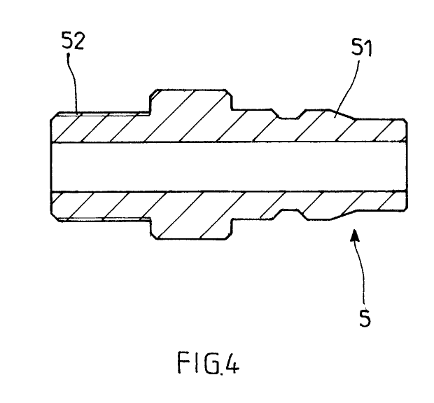

### DETAILED DESCRIPTION OF THE PREFERRED EMBODIMENT

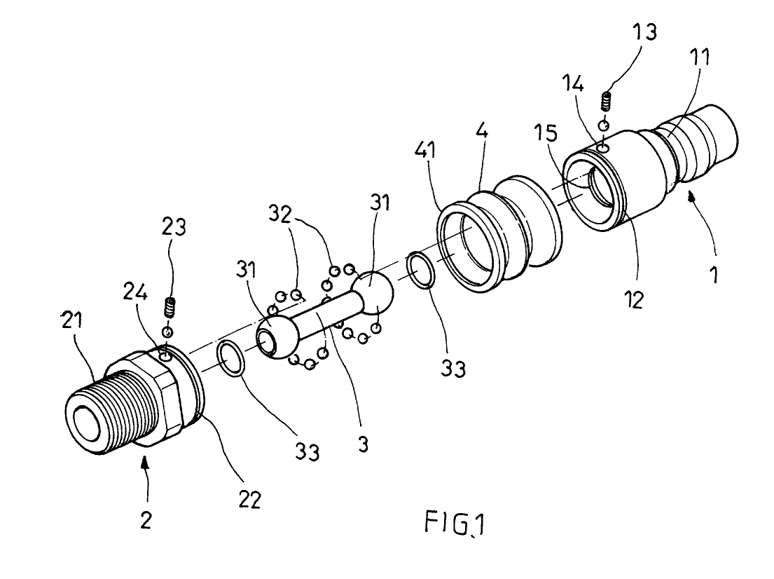

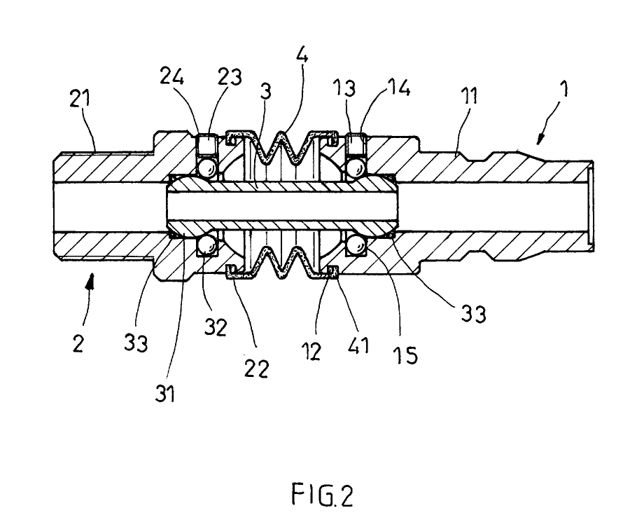

Referring to FIGS. 1 and 2, an angle-adjustable connector is adapted to connect an air-driven tool to an air compressor (or a hydraulic tool to a hydraulic press. The angle-adjustable connector is comprised of a first coupling member 1, a second coupling member 2, a connecting tube 3, and a bellows sleeve 4.

The first coupling member 1 is tubular member comprising a tubular mounting portion 11 at one end (the outer end) and connectable to the quick-release lock of a tool (not shown), an outside annular coupling groove 12 extended around the periphery at the other end (the inner end) remote from the tubular mounting portion 11, an inside annular groove 15 extended around the inside wall, a radial screw hole 14 extended through the peripheral wall in communication with the inside annular groove 15, and a screw rod 13 threaded into the radial screw hole 14.

The second coupling member 2 is shaped like a stepped short tube, comprising a threaded mounting portion 21 at one end (the outer end) connectable to a delivery tube or air compressor (not shown), an outside annular coupling groove 22 extended around the periphery at the other end (the inner end) remote from the threaded mounting portion 21, an inside annular groove 25 extended around the inside wall, a radial screw hole 24 extended through the peripheral wall in communication with the inside annular groove 25, and a screw rod 23 threaded into the radial screw hole 24.

The connecting tube 3 is connected between the first coupling member 1 and the second coupling member 2, having two hollow spherical end portions 31 at the ends. The hollow spherical end portions 31 are respectively inserted into the first coupling member 1 and the second coupling member 2.

Before threading the screw rods 13 and 23 into the radial screw holes 14 and 24 of the coupling members 1 and 2 and after insertion of the hollow spherical end portions 31 of the connecting tube 3 into the coupling members 1 and 2, steel balls 32 are respectively inserted into the radial screw holes 14 and 24. After insertion of the steel balls 32 into the radial screw holes 14 and 24, the steel balls 32 respectively move into the inside annular grooves 15 and 25 of the coupling members 1 and 2 around the periphery of the connecting tube 3 between the hollow spherical end portions 31. Therefore, the steel balls 32 stop the hollow spherical end portions 31 in the coupling members 1 and 2, preventing disconnection of the coupling members 1 and 2 from the connecting tube 3 and, allowing the coupling members 1 and 2 to be rotated relative to the connecting tube 3. Further, seal rings 33 are respectively mounted in the coupling members 1 and 2 and stopped against the hollow spherical end portions 31 of the connecting tube 3 to eliminate leakage.

The bellows sleeve 4 is connected between the coupling members 1 around the connecting tube 3, having two inside annular coupling flanges 41 disposed at two ends and respectively coupled to the outside annular coupling grooves 12 and 22 of the coupling members 1 and 2.

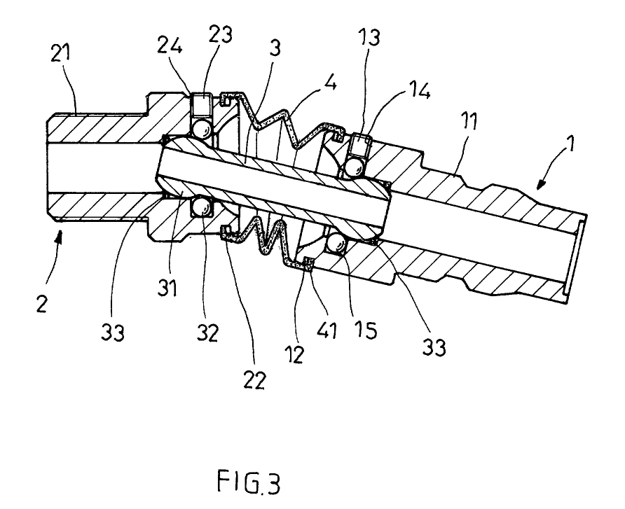

Referring to FIG. 3, the connection structure between the connecting tube 3 and the coupling member 1 or 2 forms a ball socket joint. Therefore, the coupling member 1 or 2 can be turned relative to the connecting tube 3 in different directions to different angles.

A prototype of angle-adjustable connector has been constructed with the features of FIGS. 1˜3. The angle-adjustable functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An angle-adjustable connector comprising:
a first coupling member, said first coupling member comprising a tubular mounting portion at a first end thereof connectable to the quick-release lock of a tool, an outside annular coupling groove extended around the periphery of a second end thereof, and an inside annular groove extended around an inside wall thereof, a radial screw hole extended through the periphery thereof in communication with the inside annular groove of said first coupling member;
a second coupling member, said second coupling member comprising a threaded mounting portion at a first end thereof connectable to a delivery tube or air compressor, an outside annular coupling groove extended around the periphery of a second end thereof, an inside annular groove extended around an inside wall thereof, and a radial screw hole extended through the peripheral thereof in communication with the inside annular groove of said second coupling member;
a connecting tube connected between said first coupling member and said second coupling member, said connecting tube having two hollow spherical end portions respectively inserted into the second ends of said first coupling member and said second coupling member at the ends over the inside annular grooves of said first coupling member and said second coupling member respectively;
a plurality of steel balls respectively inserted through the radial screw holes of said first coupling member and said second coupling member into the inside annular grooves of said first coupling member and said second coupling member around the periphery of said connecting tube between the hollow spherical end portions of said connecting tube to secure said first coupling member and said second coupling member to said connecting tube and for enabling said first coupling member and said second coupling member to be respectively turned relative to said connecting tube;
two screw rods respectively threaded into the radial screw holes of said first coupling member and said second coupling member to hold said steel balls in the inside annular grooves of said first coupling member and said second coupling member; and
a bellows sleeve connected between said first coupling member and said second coupling member around said connecting tube, said bellows sleeve having two inside annular coupling flanges respectively coupled to the outside annular coupling grooves of said first coupling member and said second coupling member.
